(19) United States
(12) Patent Application Publication
(10) Pub. No.: US 2008/0170781 A1
(43) Pub. Date: Jul. 17, 2008

(54) Image Selection on a Screen

(75) Inventor: David J. Woolgar, Horsham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,136

(22) PCT Filed: Sep. 15, 2005
(86) PCT No.: PCT/IB05/53028

§ 371 Date: Mar. 13, 2007

(30) Foreign Application Priority Data
Sep. 17, 2004 (GB) 0420707.2

(51) Int. Cl. G06K 9/34

(52) U.S. Cl. 382/173

(57) ABSTRACT

A method of bounding a select area (202, 204, 206) of an image on a display (200) by a select area boundary (208, 210). The select area boundary comprises at least one select area boundary portion (212, 214, 216). The method comprises actuating one of a plurality of keypad buttons (308) for a first period of time, comparing the first period of time to a threshold period of time, and in dependance on the comparison resizing the select area (202, 204, 206) or calling up a different movement function.

This invention relates to a new method for selecting part of a displayed image using a keypad and to apparatus embodying such a method. It is intended primarily for use in consumer electronics applications, but is not limited to such use.

It is common to use a pointer device or “mouse” to select icons and areas of the screen on personal computers. However for devices like mobile phones, personal digital assistants (PDA) and other consumer electronics devices the inclusion of a mouse is undesirable, due to the mouse's large space requirements and unwieldy operation that requires a flat surface.

Other input devices for controlling a pointer on a screen, such as trackballs or touch-sensitive pads are commonly used in for example laptop computers where the use of a mouse would be inconvenient. However, for smaller devices (like PDA's, mobile phones, or remote controls) trackballs or touch-sensitive pads take up too large a proportion of the space available on the device.

A common method for controlling PDA's is to use a touch sensitive display screen in conjunction with a pen or stylus that can be used to select icons or areas of the screen. This method is effective provided the user always keeps the stylus device with the PDA, however the method is not effective for other devices like for example televisions because the user is typically not in close proximity to the screen.

United States patent U.S. Pat. No. 6,678,009 describes a method of masking unwanted video artefacts by selecting the unaffected part of the screen for display using an adjustable selection box. However, to fully control the size and position of the selection box an on screen menu system is required that obscures the image. It also requires several steps to fully adjust the selection box, and is not a very elegant solution to the problem.

It is therefore an object of the present invention improve upon the known art.

According to a first aspect of the present invention, there is provided a method for bounding a select area of an image on a display by a select area boundary, said select area boundary comprising at least one select area boundary portion, the method comprising actuating one of a plurality of keypad buttons for a first period of time, comparing the first period of time to a threshold period of time, and in dependence on the comparison resizing the select area or calling up a different movement function.

Owing to the invention, it is possible to provide a select area on a display that can be very easily and intuitively adjusted and confirmed. It only requires a small number of keypad buttons to operate, and does not require any menu system to be displayed to control the keypad button's functions.

Advantageously, the select area boundary portion movements can be controlled by the use of different time period keypad button actuations. For example, the resizing the select area may move a select area boundary portion assigned to the actuated keypad button in a vector direction allocated to the actuated keypad button. During this movement, at least one select area boundary portion is suitably anchored so that the select area is resized as the select area boundary portion assigned to the actuated keypad button is moved. The select area boundary portion that is anchored is preferably opposite to the select area boundary portion assigned to the actuated keypad button. The other select area boundary portions may be modified to maintain the select area boundary as a closed shape, for example to:
maintain the internal angles of any corners existing in the original select area boundary;
maintain the shape of the original select area boundary; or
modify the select area boundary only along the axis of the allocated vector direction of the actuated keypad button.

When a keypad button is actuated to call up a different movement function, exemplary results are:
a different select area boundary portion could be assigned to the keypad button;
a different vector direction could be allocated to the keypad button;
the select area boundary could be moved in the vector direction allocated to the keypad button; or
a select area boundary portion or the select area boundary may be selected to move on the next keypad button actuation.

The select area boundary may be displayed using an outline shape corresponding to the select area boundary, or it may be displayed by other means known in the art like for example using a contrast in colour or brightness between the select area and the rest of the display.

According to a second aspect of the present invention, there is provided a system for bounding a select area of an image on a display by a select area boundary, said select area boundary comprising at least one select area boundary portion, the system comprising a keypad comprising keypad buttons operable by actuation; processing means operable to measure the time a keypad button is actuated, compare the time to a threshold period of time, and to resize the select area or call up a different movement function in dependence on the comparison; and display means (104) operable to display the image and the select area boundary.

The threshold period of time may suitably be between one tenth of a second and ten seconds, and is substantially one half of a second in preferred embodiments to be described.

The period of time that a keypad button has been actuated may be indicated to the user, by making the select area boundary appear differently dependent on whether the threshold period of time has been exceeded or not. This could easily be achieved by for example changing the colour of the select area boundary or making it flash intermittently. Another possibility would be to play a sound to the user when the threshold period of time is reached.

To indicate to the user the direction that a select area boundary portion will move in when the appropriate keypad button is actuated, the vector direction allocated to a keypad button may be displayed as an arrow on the select area boundary portion assigned to that keypad button.

Advantageously, if a select area boundary portion movement would move a portion of the select area boundary outside the displayed part of the image, the method further provides for preventing or reversing the select area boundary portion movement, or may trigger scrolling of the image if there are further portions to be displayed.

The keypad may be part of a remote control, or part of the apparatus containing the display means or the processing means. The keypad includes a plurality of keypad buttons, and may also include a keypad confirm button that may be actuated to confirm the select area. In the absence of a keypad confirm button, the select area may be implicitly confirmed by not actuating any keypad buttons for a confirmation period of time, for example from 3 to 30 seconds, or substantially 10 seconds in a preferred embodiment.

In a preferred embodiment the keypad is part of a remote control, the keypad comprising four cursor buttons that are allocated UP, RIGHT, DOWN and LEFT vector directions, and a keypad confirm button, for example the OK button commonly positioned between the cursor buttons on consumer electronics remote controls.

Keypad buttons may be actuated by touching or pressing them, or by any other means known in the art.

The display means may be any display means known in the art like for example a CRT, plasma screen, liquid crystal screen or projector.

The processing means will typically comprise one or more microprocessors, and may include a comparator for comparing a measured period of time to the threshold period of time. It may include storage for the key assignments and allocations. It may be contained within an optional set top box, within the display means, within the keypad, or be distributed between two or three of them. The processing means may have an associated storage means for storing the program required to implement the method and the actions to be performed on confirmation of the select area.

An advantage of the present invention is the ability to simply and intuitively select an area of a displayed image using only a very limited number of keypad buttons. Furthermore, the invention is well suited for integration into consumer electronics devices like for example televisions, where there is a need for a method for selecting an area of a displayed image viewed from a distance without the inconveniences of mice or trackballs. Consumer electronics remote controls comprising keypads are well accepted and understood by users. The present invention may be integrated into many consumer electronics systems, simply by upgrading set top box or other device software to implement the invention.

Embodiments of the invention will now be described, by way of example only, and with reference to the accompanying drawings, in which:—

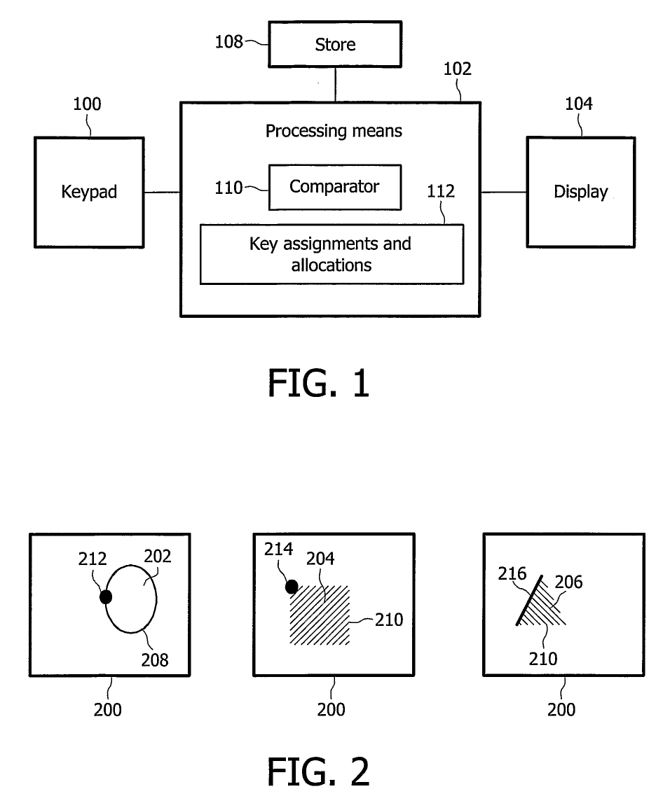

FIG. 1 shows blocks representing the keypad, display means, storage means and processing means;

FIG. 2 shows three exemplary displays, each displaying a different shaped select area boundary;

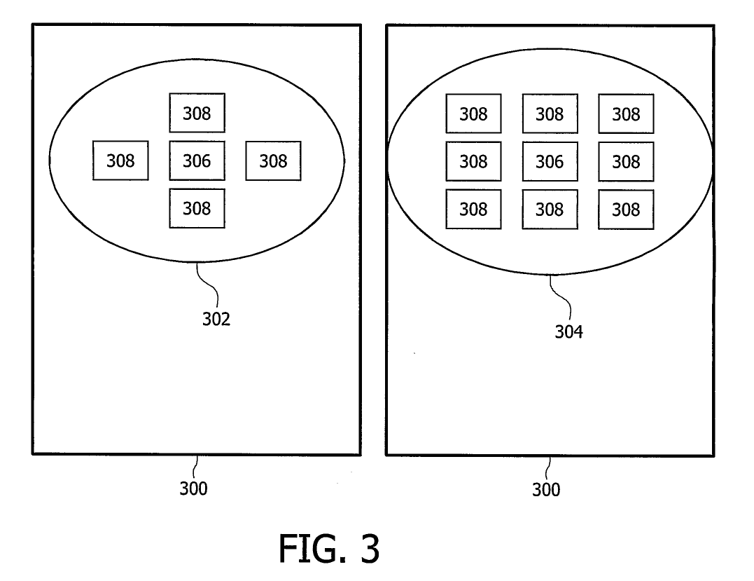

FIG. 3 shows two exemplary keypad button arrangements;

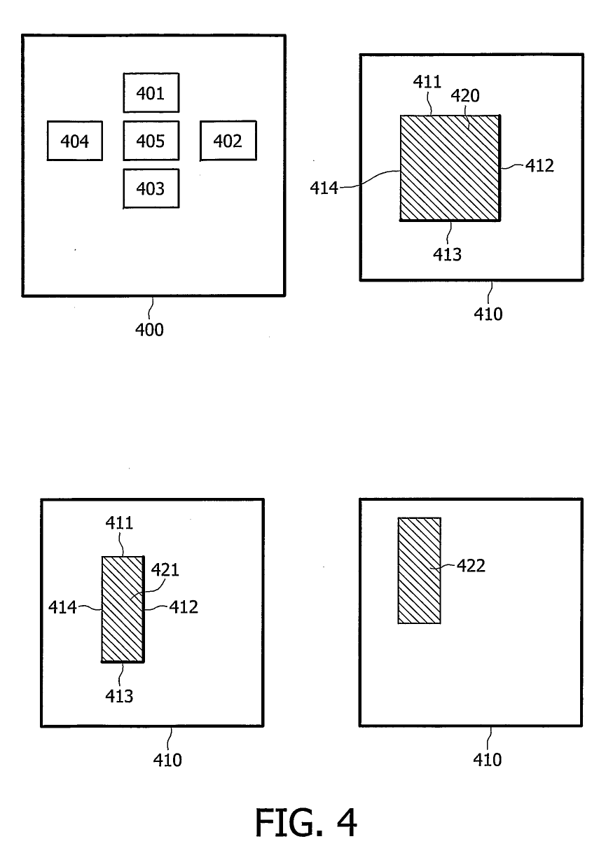

FIG. 4 illustrates first and second embodiments of the method according to the invention;

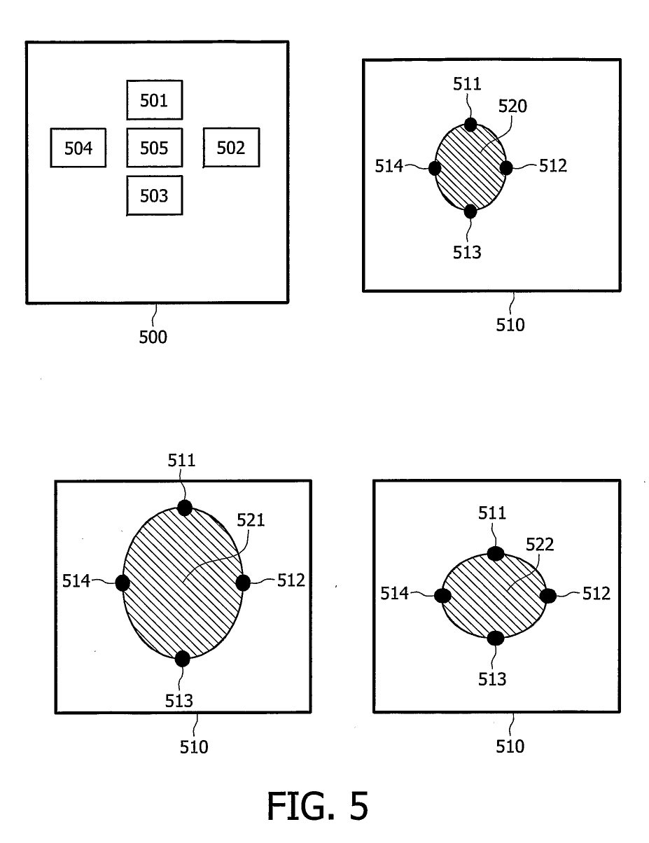

FIG. 5 illustrates a third embodiment of the method according to the invention;

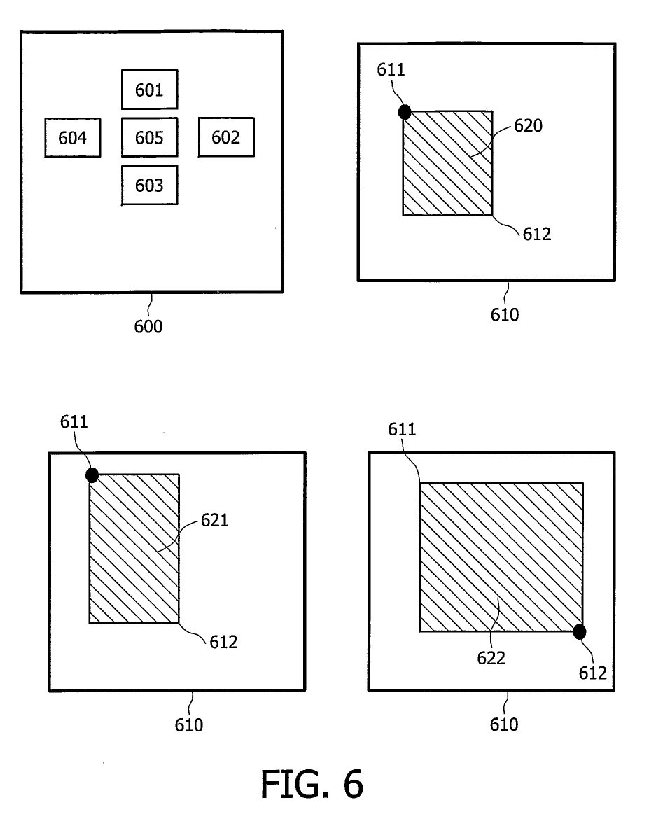

FIG. 6 illustrates a fourth embodiment of the method according to the invention; and

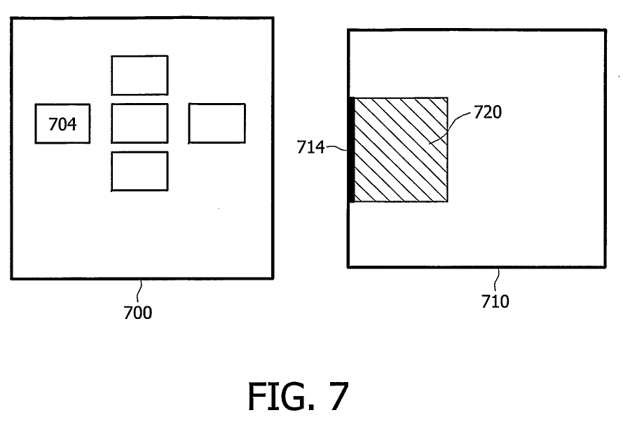

FIG. 7 shows a select area boundary close to the edge of the display.

The system shown in FIG. 1 comprises a keypad 100, a processing means 102, a storage means 108, and a display means 104. The blocks 100, 102 and 104 may be physically separate units and connected using a wired or wireless connection, or two or more of these blocks may be part of a single piece of apparatus. The processing means comprises a comparator 110 for comparing a measured period of time to a threshold period of time and storage 112 to hold the key assignments and allocations. Storage means 108 may hold the program required to implement the method and the actions to be performed when the select area is confirmed. In an exemplary embodiment the keypad 100 is part of a remote control, the processing means 102 and storage means 108 are part of a set top box, and the display means 104 is a television. The remote control communicates with the set top box using wireless (Infra-red, RF, Ultrasound) protocols known in the art such as RC5/6, Pulse Position, UWB, Wi-Fi, IRDA or Bluetooth, and the set top box has a wired connection to the television using for example a SCART, IEEE1394, S-Video, USB or co-axial cable.

FIG. 2 shows three displays 200, and each display has an exemplary shaped select area. The examples show an elliptical select area 202, a rectangular select area 204, and a triangular select area 206, although the invention is easily applied to other two dimensional shapes like for example pentagons or hexagons. Two exemplary methods for displaying the select area are shown; one method uses an outline shape 208 corresponding to the select area boundary, and the other method uses a contrast in colour or brightness 210 between the select area and the rest of the display. One select area boundary portion is shown on each select area boundary. Select area boundary portion 212 is a point on a curved side of the elliptical select area boundary. Select area boundary portion 214 is a corner of the rectangular select area boundary. Select area boundary portion 216 is a side of the triangular select area boundary.

FIG. 3 shows two exemplary keypad arrangements of keypad 300. The first arrangement 302 shows five buttons common on television remote controls that could be used to modify and confirm the select area, and the second arrangement 304 shows nine buttons common on mobile phone dialling keypads that could be used to modify and confirm the select area. A preferred use of the buttons would be to use the central button 306 for confirming the select area, and the other buttons 308 for modifying the select area boundary.

Select area boundary portions should be chosen for assignment to keypad buttons on parts of the select area boundary that can give simple control over the size and shape of the select area boundary. Select area boundary portions may be chosen to be one point or many adjacent points of the select area boundary, and may be chosen on straight sides, curved sides or corners of the select area, as described in detail in relation to FIGS. 4 to 7. Each chosen select area boundary portion is assigned to one or more keypad buttons, and may be considered as an assigned select area boundary portion.

A first embodiment will now be described in detail with reference to FIG. 4. The resizing the select area causes a select area boundary portion to be moved and the calling up a different movement function causes the select area boundary to be moved as a whole.

The keypad 400 includes four keypad buttons 401, 402, 403 and 404 for modifying the select area, and one keypad confirm button 405 for confirming the select area.

The select area is rectangular, and there are two assigned select area boundary portions chosen as sides 412 and 413. Boundary portion 412 is assigned to keypad buttons 402 and 404, and boundary portion 413 is assigned to keypad buttons 401 and 403. Sides 411 and 414 are unassigned select area boundary portions.

Keypad button 401 is allocated to an UP vector direction, keypad button 402 is allocated a RIGHT vector direction, keypad button 403 is allocated to a DOWN vector direction, and keypad button 404 is allocated to a LEFT vector direction.

The user may actuate a keypad button 401, 402, 403 or 404 to resize the select area, moving the select area boundary portion assigned to the keypad button in the vector direction allocated to the keypad button. For example keypad button 404 is assigned to select area boundary portion 412 and allocated to a LEFT vector direction, and so actuating keypad button 404 to resize the select area causes select area boundary portion 412 to move to the LEFT, resizing the select area from 420 to 421 as shown in FIG. 4. In this movement select area side 414 is anchored, and select area sides 411 and 413 are modified to maintain the internal angles of the corners in the original select area 420.

The user also may actuate a keypad button 401, 402, 404 or 404 to call up a different movement function, moving the select area boundary in the vector direction allocated to the keypad button. For example keypad button 401 is allocated to an UP vector direction, and so actuating keypad button 401 to call up a different movement function causes the select area 421 to move UP, moving the select area boundary from 421 to 422.

The user may repeatedly actuate keypad buttons 401, 402, 403, 404 to resize the select area or to call up a different movement function until they are satisfied with the size and position of the select area. Then the user actuates keypad confirm button 405 to confirm the select area. It will be appreciated that the keypad buttons 401, 402, 403, and 404 give complete control over the size and position of the select area on the display.

This embodiment describes a rectangular select area, however it could be easily applied to different shape select areas like for example ellipses and triangles. For each select area boundary portion to be controlled, a common select area boundary portion is assigned to two keypad buttons, and opposing vector directions are allocated to the two keypad buttons.

In this embodiment the resizing the select area is orientated to occur when a keypad button is actuated for a period of time less than the threshold period of time, and the calling up a different movement function orientated to occur when a keypad button is actuated for a period of time greater than the threshold period of time. However, it will be appreciated that reversing this orientation would give another very similar working embodiment.

A second embodiment will now be described in detail also with reference to FIG. 4. The calling up a different movement function selects moving a select area boundary portion or moving the select area boundary on the next keypad button actuation. In this embodiment, as selected by the calling up a different movement function, the resizing the select includes moving a select area boundary portion or moving the select area boundary.

The keypad 400 includes four keypad buttons 401, 402, 403 and 404, and one keypad confirm button 405 for confirming the select area.

The select area is rectangular, and there are two assigned select area boundary portions chosen as sides 412 and 413. Boundary portion 412 is assigned to keypad buttons 402 and 404, and boundary portion 413 is assigned to keypad buttons 401 and 403. Sides 411 and 414 are unassigned select area boundary portions.

Keypad button 401 is allocated to an UP vector direction, keypad button 402 is allocated a RIGHT vector direction, keypad button 403 is allocated to a DOWN vector direction, and keypad button 404 is allocated to a LEFT vector direction.

The user may actuate a keypad button 401, 402, 404 or 404 to call up a different movement function, selecting whether on the next keypad actuation a select area boundary portion or the select area boundary should be moved. If before a calling up a different movement function the keypad buttons are selected to move a select area boundary portion, then after the calling up a different movement function the keypad buttons are selected to move the select area boundary. Calling up a different movement function again will cause re-selection of keypad buttons moving a select area boundary portion.

The user may actuate a keypad button 401, 402, 403 or 404 to resize the select area.

When moving a select area boundary portion is selected, the resizing the select area operates in the same way as in the first embodiment. For example, keypad button 404 is assigned to select area boundary portion 412 and allocated to a LEFT vector direction, and so actuating keypad button 404 to resize the select area causes select area boundary portion 412 to move to the LEFT, resizing the select area from 420 to 421 as shown in FIG. 4. In this movement select area side 414 is anchored, and select area sides 411 and 413 are modified to maintain the internal angles of the corners in the original select area 420.

When moving the select area boundary is selected, the resizing the select area operates in the same way as the calling up a different movement function operates in the first embodiment. For example, keypad button 401 is allocated to an UP vector direction, and so actuating keypad button 401 to resize the select area causes the select area 421 to move UP, moving the select area boundary from 421 to 422.

The user may repeatedly actuate keypad buttons 401, 402, 403, 404 to resize the select area or to call up a different movement function until they are satisfied with the size and position of the select area. Then the user actuates keypad confirm button 405 to confirm the select area. It will be appreciated that the keypad buttons 401, 402, 403, and 404 give complete control over the size and position of the select area on the display.

This embodiment describes a rectangular select area, however it could be easily applied to different shape select areas like for example ellipses and triangles. For each select area boundary portion to be controlled, a common select area boundary portion is assigned to two keypad buttons, and opposing vector directions are allocated to the two keypad buttons.

In this embodiment the resizing the select area is orientated to occur when a keypad button is actuated for a period of time greater than the threshold period of time, and the calling up a different movement function orientated to occur when a keypad button is actuated for a period of time less than the threshold period of time. This orientation is preferred so the select area boundary is resized further the longer a keypad button is actuated. It will be appreciated that reversing this orientation would give another working embodiment, however the select area boundary could not be resized further the longer a keypad button was actuated. The threshold period of time would be reached and the keypad button actuation would call up a different movement function instead of resizing. In that case it would be preferred for the select area to be resized by a fixed amount each time a keypad button was actuated to resize the select area. The size of the fixed amount would be a trade-off between speed and accuracy, with small fixed amounts allowing accurate positioning, but requiring many keypad button actuations to move a select area boundary portion or the select area boundary a useful distance.

An advantage of this embodiment is that both a select area boundary portion and the select area boundary may be moved as a result of actuating a keypad button for a period of time greater than the threshold period of time. This means that both a select area boundary portion and the select area boundary may be moved further the longer a keypad button is actuated, making the embodiment well suited to applications where fast and accurate positioning of the select area is required.

When a keypad button is actuated, a select area boundary portion or the select area may move faster the longer the keypad button is actuated. Moving the select area boundary portion or the select area boundary slowly when the threshold period of time is first exceeded will enable accurate positioning, and moving the select area boundary portion or the select area boundary faster and faster as the keypad button continues to be actuated will enable the select area boundary portion or the select area boundary to move large distances quickly.

Although the first two embodiments have given examples of moving the select area boundary by translating its position, further embodiments may be envisaged where moving the select area boundary is achieved without changing the central position of the select area, by moving every select area boundary portion towards or away from the central position of the select area.

A third embodiment will now be described in detail with reference to FIG. 5. The resizing the select area causes a select area boundary portion to be moved and the calling up a different movement function causes the actuated keypad button to be allocated a different vector direction.

The keypad 500 includes four keypad buttons 501, 502, 503 and 504, and one keypad confirm button 505 for confirming the select area.

The select area is elliptical and there are four assigned select area boundary portions chosen at the topmost, rightmost, bottommost and leftmost points of the select area boundary, referenced as 511, 512, 513 and 514 respectively. Boundary portions 511, 512, 513, and 514 are assigned to keypad buttons 501, 502, 503, and 504 respectively.

Keypad button 501 is allocated to an UP vector direction, keypad button 502 is allocated a RIGHT vector direction, keypad button 503 is allocated to a DOWN vector direction, and keypad button 504 is allocated to a LEFT vector direction.

The user may actuate a keypad button 501, 502, 503 or 504 to resize the select area, moving the select area boundary portion assigned to the keypad button in the vector direction allocated to the keypad button. For example keypad button 502 is assigned to select area boundary portion 512 and allocated to a RIGHT vector direction, and so actuating keypad button 502 to resize the select area causes select area boundary portion 512 to move to the RIGHT. In this movement select area boundary portion 514 is anchored, and the rest of the select area boundary moves so as to maintain the shape of the select area, modifying the select area from 520 to 521 as shown in FIG. 5.

In this embodiment the shape of the select area ellipse does not change as the select area boundary is moved to maintain it. Another exemplary option would be to restrict the select area boundary to movement only in the vector direction allocated to the actuated keypad button, stretching or compressing the ellipse along the axis of that vector direction. For example on actuation of keypad button 502 to resize the select area, select area 520 would be modified to select area 522 instead of to select area 521.

The user may also actuate a keypad button 501, 502, 503, or 504 to call up a different movement function, reversing the vector direction allocated to the keypad button. This enables the user to move a boundary portion in a second vector direction, opposite to the previously allocated vector direction. Continuing the previous example from select area 521, the user may wish to return from select area 521 back to select area 520. To do this the user first actuates keypad button 502 to call up a different movement function, allocating keypad button 502 to a RIGHT vector direction opposite to the LEFT vector direction previously allocated. Then the user actuates keypad button 502 to resize the select area, moving select area boundary portion 512 to the RIGHT and returning to select area 520.

The user may repeatedly actuate keypad buttons 501, 502, 503, 504 to resize the select area or to call up a different movement function until they are satisfied with the size and position of the select area. Then the user may actuate keypad confirm button 505 to confirm the select area. It will be appreciated that the keypad buttons 501, 502, 503, and 504 give complete control over the size and position of the select area on the display.

This embodiment describes an elliptical select area, however it could be easily applied to different shape select areas like for example rectangles or triangles by choosing select area boundary portions and assigning each one to a respective keypad button.

In this embodiment the resizing the select area is orientated to occur when a keypad button is actuated for a period of time greater than the threshold period of time, and the calling up a different movement function orientated to occur when a keypad button is actuated for a period of time less than the threshold period of time. This orientation is preferred so the select area boundary is resized further the longer a keypad button is actuated. It will be appreciated that reversing this orientation would give another working embodiment, however the select area boundary could not be resized further the longer a keypad button was actuated. The threshold period of time would be reached and the keypad button actuation would call up a different movement function instead of resizing. In that case it would be preferred for the select area to be resized by a fixed amount each time a keypad button was actuated to resize the select area.

An advantage of this embodiment is that every single keypad button controls a different select area boundary portion. This means that many different select area boundary portions can be directly controlled, without the requirement for calling up a different movement function.

A fourth embodiment will now be described in detail with reference to FIG. 6. The resizing the select area causes a select area boundary portion to be moved and the calling up a different movement function causes a different select area boundary portion to be assigned to all of the keypad buttons.

The keypad 600 includes four keypad buttons 601, 602, 603 and 604, and one keypad confirm button 605 for confirming the select area.

The select area is rectangular, and there is one assigned select area boundary portion 611 at a corner of the rectangle. Boundary portion 611 is assigned to all four keypad buttons 601, 602, 603, and 604.

Keypad button 601 is allocated to an UP vector direction, keypad button 602 is allocated a RIGHT vector direction, keypad button 603 is allocated to a DOWN vector direction, and keypad button 604 is allocated to a LEFT vector direction.

The user may actuate a keypad button 601, 602, 603, or 604 to resize the select area, moving the select area boundary portion assigned to the keypad button in the vector direction allocated to the keypad button. For example keypad button 601 is assigned to select area boundary portion 611 and allocated to an UP vector direction, and so actuating keypad button 601 to resize the select area causes select area boundary portion 611 to move UP, resizing the select area from 620 to 621 as shown in FIG. 6. In this movement unassigned select area boundary portion 612 is anchored, and the rest of the select area boundary is modified to maintain the internal angles of the corners in the original select area 620.

The user may also actuate a keypad button 601, 602, 603, or 604 to call up a different movement function, assigning all four keypad buttons to a different select area boundary portion. This enables the user to step through different select area boundary portions and move each one. Continuing the previous example from select area 621, a keypad button 601, 602, 603, or 604 is actuated to call up a different movement function, assigning all four keypad buttons 601, 602, 603, and 604 to select area boundary portion 612 instead of 611. Then the keypad button 602 is actuated to resize the select area, causing select area boundary portion 612 to move RIGHT, resizing the select area from 621 to 622 as shown in FIG. 6. In this movement the now unassigned select area boundary portion 611 is anchored, and the rest of the select area boundary is modified to maintain the internal angles of the corners of the original select area boundary 620.

The user may repeatedly actuate keypad buttons 601, 602, 603, 604 to resize the select area or to call up a different movement function until they are satisfied with the size, shape and position of the select area. Then the user may actuate keypad confirm button 605 to confirm the select area. It will be appreciated that the keypad buttons 601, 602, 603, and 604 give complete control over the size and position of the select area on the display.

This embodiment describes a rectangular select area, however it could be easily applied to different shape select areas like for example ellipses and triangles by choosing select area boundary portions and assigning keypad buttons to them in the same manner.

In this embodiment the resizing the select area is orientated to occur when a keypad button is actuated for a period of time greater than the threshold period of time, and the calling up a different movement function orientated to occur when a keypad button is actuated for a period of time less than the threshold period of time. This orientation is preferred so the select area boundary is resized further the longer a keypad button is actuated. It will be appreciated that reversing this orientation would give another working embodiment, however the select area boundary could not be resized further the longer a keypad button was actuated. The threshold period of time would be reached and the keypad button actuation would call up a different movement function instead of resizing. In that case it would be preferred for the select area to be resized by a fixed amount each time a keypad button was actuated to resize the select area.

An advantage of this embodiment over the others described herein is that any rectangular select area size or position can be obtained by calling up a different movement function only once, to switch between the two select area boundary portions. This makes this embodiment very quick to use when a large variety of select area sizes and positions may be required.

The processing means may choose to ignore or reverse a select area boundary movement to prevent the select area boundary moving outside the area of the display. This is now described in detail with reference to FIG. 7. An exemplary rectangular select area 720 is displayed at the edge of the display 710. The select area boundary portion 714 forms the leftmost edge of the rectangle and is positioned at the edge of the display. The keypad button 704 is assigned to select area boundary portion 714 and allocated to a LEFT vector direction. If keypad button 704 was actuated for a period of time less than the threshold period of time then select area boundary portion 714 would normally move LEFT and off the display. To prevent this the response to the actuation of keypad button 704 may be altered, for example:
actuating keypad button 704 causes no movement of the select area boundary portion; or
actuating keypad button 704 causes the vector direction allocated to the keypad button to reverse, moving the select area boundary portion RIGHT and back into the display.

It will be appreciated that there are many possible variations to the embodiments described and that they could be simply modified to different numbers of keypad buttons, different shaped select areas, different vector direction allocations and different select area boundary portion assignments. It is also an option to add a second threshold period of time that could be used to give even more flexibility to the select area modification method. For example, if a keypad button was actuated for a period of time less than both threshold periods of time then the select area boundary could be moved in the vector direction associated with the keypad button. If the keypad button was actuated for a period of time greater than the first threshold period of time but less than the second threshold period of time, then the vector direction allocated to the keypad button could be reversed. If the keypad button was actuated for a period of time greater than both threshold periods of time then the keypad could be assigned to a different select area boundary portion.

Typical uses of the select area include:
selecting part of the displayed image for a zooming or image processing operations;
selecting part of the displayed image for writing to a file;
selecting part of the displayed image containing a mark, in order to execute a file linked to the mark; and
selecting part of the displayed image containing a mark, in order to skip a commercial break in an audio-visual program.

1. A method of bounding a select area (202, 204, 206) of an image on a display (200) by a select area boundary (208, 210), said select area boundary comprising at least one select area boundary portion (212, 214, 216), the method comprising actuating one of a plurality of keypad buttons (308) for a first period of time, comparing the first period of time to a threshold period of time (110), and in dependence on the comparison resizing the select area (202, 204, 206) or calling up a different movement function.

2. A method according to claim 1, wherein the resizing the select area (420) moves a select area boundary portion (412) assigned to the actuated keypad button (404) in a vector direction allocated to the actuated keypad button.

3. A method according to claim 1, wherein a select area boundary portion (611) is assigned to a keypad button, and wherein the calling up a different movement function assigns a different select area boundary portion (612) to the keypad button.

4. A method according to claim 1, wherein a vector direction is allocated to a keypad button, and wherein the calling up a different movement function allocates a different vector direction to the keypad button.

5. A method according to claim 1, wherein the calling up a different movement function moves the select area boundary in a vector direction allocated to the actuated keypad button.

6. A method according to claim 1, wherein the calling up a different movement function selects moving a select area boundary portion or moving the select area boundary on the next keypad button actuation.

7. A method according to claim 1, wherein the threshold period of time is substantially one half of a second.

8. A method according to claim 2, wherein a keypad button is actuated for a period of time greater than the threshold period of time, and wherein the longer the keypad button is actuated the faster select area boundary portions move.

9. A method according to claim 2, wherein other select area boundary portions are modified to maintain the select area boundary as a closed shape.

10. A method according to claim 2, wherein at least one select area boundary portion is anchored.

11. A method according to claim 1, wherein two keypad buttons (402, 404) are assigned to a common select area boundary portion (412), and said two keypad buttons allocated to opposing vector directions.

12. A method according to claim 1, wherein a select area boundary portion movement is prevented if the select area boundary portion movement would move a select area boundary portion (714) outside of the display.

13. A method according to claim 1, wherein a select area boundary portion movement is reversed if the select area boundary portion movement would move a select area boundary portion (714) outside of the display.

14. Software for causing a processor to perform the method according to claim 1.

15. A system for bounding a select area (202, 204, 206) of an image on a display (200) by a select area boundary (208, 210), said select area boundary comprising at least one select area boundary portion (212, 214, 216), the system comprising a keypad (100) comprising keypad buttons (308) operable by actuation; processing means (102) operable to measure the time a keypad button is actuated, compare the time to a threshold period of time (110), and to resize the select area or call up a different movement function in dependence on the comparison; and display means (104) operable to display the image and the select area boundary.

16. A system according to claim 15, wherein the processing means resizes the select area by moving a select area boundary portion (412) assigned to the actuated keypad button (404) in a vector direction allocated to the actuated keypad button.

17. A system according to claim 15, wherein a select area boundary portion (611) is assigned to a keypad button, and wherein the processing means assigns a different select area boundary portion (612) to the keypad button on calling up a different movement function.

18. A system according to claim 15, wherein a vector direction is allocated to a keypad button, and wherein the processing means allocates a different vector direction to the keypad button on calling up a different movement function.

19. A system according to claim 15, wherein the processing means moves the select area boundary in a vector direction allocated to the actuated keypad button on calling up a different movement function.

20. A system according to claim 15, wherein the processing means selects moving a select area boundary portion or moving the select area boundary for the next keypad actuation on calling up a different movement function.

21. A system according to claim 16, wherein the processing means moves select area boundary portions faster the longer the keypad button is actuated over the threshold period of time.

22. A system according to claim 16, wherein the processing means modifies other select area boundary portions to maintain the select area boundary as a closed shape.

23. A system according to claim 16, wherein the processing means anchors at least one select area boundary portion.

24. A system according to claim 15, wherein the processing means prevents a select area boundary portion movement if the select area boundary portion movement would move a select area boundary portion (714) outside the area of the displayed image.

25. A system according to claim 15, wherein the processing means reverses a select area boundary portion movement if the select area boundary portion movement would move a select area boundary portion (714) outside the area of the displayed image.

26. A system according to claim 15, wherein two keypad buttons (402, 404) are assigned to a common select area boundary portion (412), and said two keypad buttons allocated to opposing vector directions.

27. A system according to claim 15, wherein the keypad is part of a remote control.

28. A system according to claim 15, wherein the keypad buttons are four cursor buttons.

29. A system according to claim 15, wherein the keypad comprises a keypad confirm button (306) operable by actuation to command the processing means to confirm the select area boundary.

30. A system according to claim 15, wherein the processing means confirms the select area boundary when no keypad button is actuated for a confirmation period of time.
